(19) United States
(12) Patent Application Publication
(10) Pub. No.: US 2022/0129418 A1
(43) Pub. Date: Apr. 28, 2022

(54) METHOD FOR DETERMINING BLOOD RELATIONSHIP OF DATA, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Weibin YE, Beijing (CN); Jintao CUI, Beijing (CN); Zhenfei FAN, Beijing (CN); Tao LIU, Beijing (CN)

(73) Assignee: BEIJING BAIDU NETCOM SCIENCE TECHNOLOGY CO., LTD., Beijing (CN)

(21) Appl. No.: 17/573,233

(22) Filed: Jan. 11, 2022

(30) Foreign Application Priority Data
Feb. 5, 2021 (CN) 202110164611.X

(51) Int. Cl. G06F 16/16; G06F 16/182

(52) U.S. Cl. CPC G06F 16/164; G06F 16/182

(57) ABSTRACT

A method for determining blood relationship of data, an electronic device and a storage medium. The specific implementation solution is: acquiring data to be processed and initial meta information corresponding thereto; matching the initial meta information with respective reference meta information sets, respectively, to determine a target meta information set that matches the initial meta information; determining the blood relationship corresponding to the data according to the target meta information set.

### CROSS-REFERENCE TO RELATED APPLICATIONS

This application claims the benefit of priority to Chinese Application No. 202110164611.X, filed on Feb. 5, 2021, the contents of which are incorporated herein by reference in their entirety.

### TECHNICAL FIELD

The present disclosure relates to the field of data processing technology, in particular to the field of artificial intelligence technology such as information flow and big data, and particularly to a method for determining blood relationship of data, an electronic device and a storage medium.

### BACKGROUND

With the advent of the era of big data, explosive growth of data presents, and various types of and massive amounts of data are being rapidly generated. These huge and complex items of data information, through marriage, fusion, conversion, transformation, circulation and communication, in turn generate new data and converge into ocean of data. In the process of data processing, every link, from the source of the data to the final data generation, may affect the accuracy of data quality. So in the process of data detection and processing, how to accurately determine blood relationship of the data is very important.

### SUMMARY

The present disclosure provides a method for determining blood relationship of data, an electronic device and a storage medium.

In one aspect of the present disclosure, a method for determining blood relationship of data is provided, which includes: acquiring data to be processed and initial meta information corresponding thereto; matching the initial meta information with respective reference meta information sets, respectively, to determine a target meta information set that matches the initial meta information; determining the blood relationship corresponding to the data according to the target meta information set.

In another aspect of the present disclosure, an electronic device is provided, which includes: at least one processor; and a memory communicatively connected with the at least one processor. Instructions executable by the at least one processor are stored in the memory, and the instructions are executed by the at least one processor, so that the at least one processor can execute the method for determining the blood relationship of the data according to an embodiment of the above aspect.

In another aspect of the present disclosure, a non-transitory computer-readable storage medium is provided, in which computer instructions are stored, and on which a computer program is stored. The computer instructions are configured to cause a computer to execute the method for determining the blood relationship of the data according to an embodiment of the above aspect.

It should be understood that the content described in the present section is not intended to identify the key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the present solution, and do not constitute a limitation to the present disclosure, in which:

FIG. 1 is a schematic flowchart of a method for determining blood relationship of data provided by an embodiment of the present disclosure;

FIG. 2 is a schematic flowchart of a method for determining blood relationship of data provided by another embodiment of the present disclosure;

FIG. 3 is a schematic flowchart of a method for determining blood relationship of data provided by further another embodiment of the present disclosure;

FIG. 4 is a schematic structural diagram of an apparatus for determining blood relationship of data provided by an embodiment of the present disclosure;

FIG. 5 is a schematic structural diagram of an apparatus for determining blood relationship of data provided by another embodiment of the present disclosure;

FIG. 6 is a block diagram of an electronic device used to implement the method for determining blood relationship of data according to an embodiment of the present disclosure.

### DETAILED DESCRIPTION

The following describes exemplary embodiments of the present disclosure with reference to the accompanying drawings, which include various details of the embodiments of the present disclosure to facilitate understanding, and should be regarded as merely exemplary. Therefore, those of ordinary skill in the art should recognize that various changes and modifications can be made to the embodiments described herein without departing from the scope and spirit of the present disclosure. Likewise, for clarity and conciseness, descriptions of well-known functions and structures are omitted in the following description.

Artificial intelligence is a subject that studies how to cause a computer to simulate certain thinking processes and intelligent behaviors (such as learning, reasoning, thinking, planning, etc.) of human, and has not only hardware-level technologies and but also software-level technologies. The hardware technologies of the artificial intelligence generally include technologies such as sensors, dedicated artificial intelligence chips, cloud computing, distributed storage, and big data processing; and the software technologies of the artificial intelligence mainly include several major directions such as computer vision technology, speech recognition technology, natural language processing technology, and machine learning, deep learning, big data processing technology, and knowledge graph technology etc.

Big data technology refers to realizing of collection of large amounts of data through multiple kinds of channels, and realizing of deep mining and analysis of data by using cloud computing technology, to ensure that laws and characteristics between data can be found in a timely manner, and value of the presence of the data can be summarized and inducted. The big data technology is very important for understanding data characteristics and predicting development trends.

There are two types of information flow in a broad sense and in a narrow sense. Information flow in a broad sense refers to a group of items of information in the process of moving in the same direction in space and time, which have a common information source and information receiver, that is, the collection of all information transmitted from one information source to another unit. Information flow in a narrow sense refers to the transmission movement of information, and this transmission movement of information is carried out through certain channels in accordance with certain requirements in the conditions of research, development and application of the modern information technology.

The method, the apparatus, the electronic device and the storage medium for determining blood relationship of data of embodiments of the present disclosure will be described below with reference to the accompanying drawings.

The method for determining the blood relationship of the data in an embodiment of the present disclosure may be executed by the apparatus for determining the blood relationship of the data provided in an embodiment of the present disclosure, which may be configured in an electronic device.

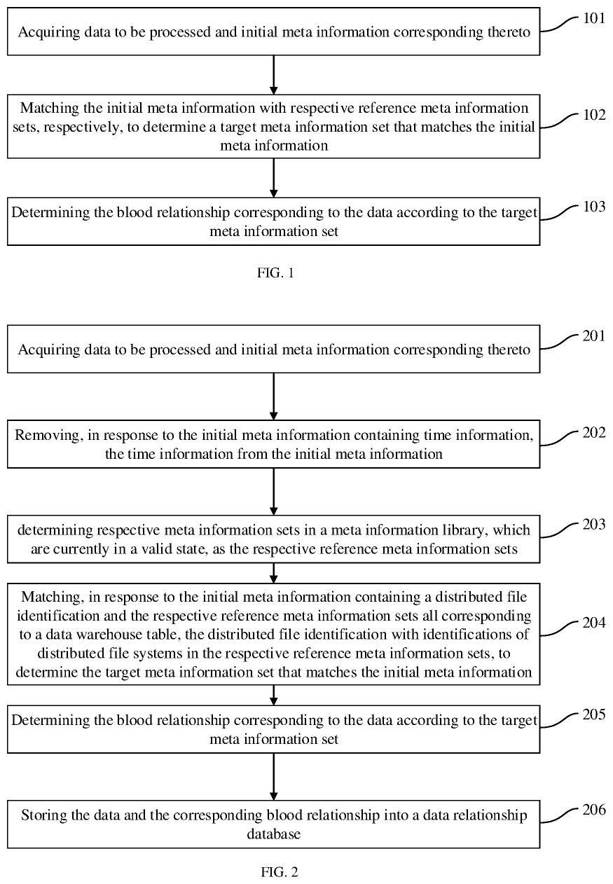

FIG. 1 is a schematic flowchart of a method for determining blood relationship of data provided by an embodiment of the present disclosure.

As shown in FIG. 1, the method for determining the blood relationship of the data may include the following steps.

At block 101, data to be processed and initial meta information corresponding thereto are acquired.

The initial meta information is the data contained in the data to be processed and related to the blood of the data to be processed. For example, the initial meta information may include information on the source of the data, or it may also include information on the storage of the data, etc., which will be not limited by the present disclosure.

At block 102, the initial meta information is matched with respective reference meta information sets, respectively, to determine a target meta information set that matches the initial meta information.

The reference meta information set is pre-generated and can be used to uniquely characterize the meta information of the blood relationship of a certain data. Each reference meta information set may include one item of reference meta information, or may also include multiple items of reference meta information, which will not be limited by the present disclosure.

In addition, the reference meta information set may have multiple kinds of data sources. For different data sources, the information thereon contained in the reference meta information set may be different.

For example, the reference meta information set may be generated based on a meta information set corresponding to a distributed file system, and the reference meta information set may include information on cluster address, basic data path, data set path, data ready identifier, time wildcard placeholder, and access secret key, and the like, which will not be limited by the present disclosure.

Alternatively, the reference meta information set may be generated based on a meta information set corresponding to a data warehouse table, and the reference meta information may include information on its logically mapped distributed file system identification, data warehouse table namespace, data warehouse name, data warehouse table name, partition key, field list, and the like, which will not be limited by the present disclosure.

It is understandable that the reference meta information in the distributed file system can be associated through the corresponding logically mapped distributed file system identification in the data warehouse table, so that the reference meta information in the distributed file system can be obtained through the data warehouse table.

It is understandable that all the contents contained in the initial meta information can be matched with the respective reference meta information sets one by one, and the reference meta information set, with which all the contents contained in the initial meta information successfully match, will be determined as the target meta information set.

For example, the information contained in the initial meta information 1 is: data warehouse namespace A, data warehouse table a, and the information contained in reference meta information set 1 is: data warehouse namespace B, data warehouse table b, etc., the information contained in the reference meta information set 2 is: data warehouse namespace A, data warehouse name d, data warehouse table a, etc., and the reference meta information set 2 contains all the information in the initial meta information 1, so that it can be determined that the reference meta information set 2 is the target meta information set that matches with the initial meta information 1.

Or the information contained in the initial meta information 1 is: distributed file A, secret key X, and the information contained in the initial meta information 2 is: distributed file A, basic data path N, and the information contained in the reference meta information set 2 is: distributed file A, basic data path N, secret key X, data ready identifier Z, etc. The reference meta information set 2 contains not only all the information in the initial meta information 1, but also all the information in the initial meta information 2, so that it can be determined that the target meta information sets of the two both are the reference meta information set 2.

It should be noted that the above examples are only exemplifications and cannot be used as limitations on the initial meta information, reference meta information set, target meta information set, etc. in the embodiments of the present disclosure.

At block 103, the blood relationship corresponding to the data is determined according to the target meta information set.

It is understandable that multiple items of initial meta information matching the same target meta information set may have corresponding blood relationships of data.

In addition, there may be multiple kinds of the blood relationships of the data, which for example may be inclusive relationship, attributive relationship, hierarchical relationship, etc., which will not be limited by the present disclosure.

For example, the initial meta information 1, the initial meta information 2, and the initial meta information 3 all correspond to the same target meta information set a, so that it can be determined that there is a corresponding blood relationship among three data to be processed, to which the initial meta information 1, 2, and 3 respectively correspond.

It should be noted that the above examples are only exemplifications, and cannot be used as limitations on the target meta information set, blood relationship, etc. in the embodiments of the present disclosure.

It should be noted that in related technologies, when processing data to determine the blood relationship of the data, it needs to be determined according to a certain time period and in combination with other data associated before and after the data, which may in turn cause the present of problems on periodicity, Lagging and the like in the blood relationship of the data. In the solution in the present disclosure, based on meta information of the data itself and the reference meta information sets generated in advance, each piece of data can be matched, without considering information on other data associated before and after the data, so that the data can be processed in real time and thereby the blood relationship corresponding to the data can be determined.

According to the embodiment of the present disclosure, data to be processed and initial meta information corresponding thereto will be acquired first, and afterwards the initial meta information can be matched with the respective reference meta information sets, respectively, to determine a target meta information set that matches the initial meta information, so that the blood relationship corresponding to the data can be determined according to the target meta information set. Therefore, the blood relationship corresponding to the data will be determined according to the matching result of the initial meta information corresponding to the data and the respective reference meta information sets, and because each reference meta information set can uniquely characterize the blood relationship of one piece of data, the risk of misjudgment of blood relationship of the data can be effectively reduced, and the accuracy and reliability of the determination of the blood relationship of the data can be improved.

In the above embodiment, by matching the initial meta information corresponding to the data with the respective reference meta information sets, respectively, a target meta information set that matches the initial meta information will be determined, and afterwards the blood relationship corresponding to the data can be determined. In a possible implementation, when the initial meta information is matched with the reference meta information sets, the initial meta information may include time information. In order to reduce the complexity of matching the initial meta information with the reference meta information sets, in the present disclosure, the time information can be processed first, and the above process will be further described with reference to FIG. 2 below.

FIG. 2 is a schematic flowchart of a method for determining blood relationship of data provided by an embodiment of the present disclosure.

As shown in FIG. 2, the method for determining the blood relationship of the data may include the following steps.

At block 201, data to be processed and initial meta information corresponding thereto are acquired.

At block 202, in response to the initial meta information containing time information, the time information from the initial meta information is removed.

It is understandable that the stored path of the data from the same data source may be changed at different moments. If the relationship of the data is directly judged, the data having a blood relationship may be misjudged, which may cause inaccurate blood relationship of the data.

For example, if an operation B is performed on an application A, the corresponding storage path corresponding to data A1 generated in a time period 1 may be M, and afterwards the operation B is continued on the application A, and the corresponding storage path corresponding to data A2 generated in a time period 2 may be N, and the corresponding storage path of data A3 generated in a time period 3 may be L. All other items of information of the information contained in the data A1, A2, and A3, except for the different time information and storage path caused by the time information, may be the same. If the matching is directly performed according to the storage paths, the data A1, A2, and A3 may be mistaken as data without blood relationship. Therefore, in order to further improve the accuracy of determining the blood relationship of the data, the time information in the initial meta information can be removed first.

In the embodiment of the present disclosure, in order to further improve the accuracy of determining the blood relationship of the data, the time information in the initial meta information can be removed first, so that in determining the blood relationship of the data, the influence caused by the time information can be reduced, thereby improving the accuracy of determining the blood relationship of the data.

At block 203, respective meta information sets in a meta information library, which are currently in a valid state, are determined as the respective reference meta information sets.

The respective meta information sets in the meta information library may be preset by the user in advance according to the meta information sets corresponding to the distributed file system or the data warehouse table, or may also be acquired by the meta information library through a request to the distributed file system or the data warehouse table, which will not be limited by the present disclosure.

In actual use, in order to further ensure the accuracy of the determined blood relationship of the data, the apparatus for determining the blood relationship of the data can periodically perform synchronization of the meta information sets with the distributed file systems or the data warehouse tables corresponding to the respectively meta information sets, and only the successfully synchronized meta information sets will be set to a valid state, that is, only the successfully-synchronized meta information sets will be determined as the reference meta information sets.

It should be noted that the order of execution of the step 202 and the step 203 can be performed sequentially or simultaneously. The present disclosure will be described and explained by only exemplifying the step 203 to be executed after the step 202 in the present disclosure, which cannot be used as limitation on the present disclosure.

At block 204, in response to the initial meta information containing a distributed file identification and the respective reference meta information sets all corresponding to a data warehouse table, the distributed file identification is matched with identifications of distributed file systems in the respective reference meta information sets, to determine the target meta information set that matches the initial meta information.

The initial meta information may include the distributed file system identification, and the respective reference meta information sets only correspond to the data warehouse table, that is, each reference meta information set contains the distributed file system identification logically mapped thereto. Therefore, when matching the initial meta information with the reference meta information sets, the distributed file system identification in the initial meta information can be matched with the distributed file system identifications in the respective reference meta information sets.

For example, the information contained in the initial meta information 1 is: distributed file system a, cluster address Q, and the reference meta information set corresponding to a data warehouse table 1 contains distributed file system a, and the reference meta information set corresponding to a data warehouse table 2 contains distributed file system b. The distributed file system a in the initial meta information 1 is the same as the distributed file system a in the reference meta information set corresponding to the data warehouse table 1, so that it can be determined that the reference meta information set corresponding to the data warehouse table 1 is the target meta information set that matches with the initial meta information 1.

It should be noted that the above examples are only exemplifications and cannot be used as limitations on the distributed file identification, distributed file system identification, target meta information set, etc. in the embodiments of the present disclosure.

At block 205, the blood relationship corresponding to the data is determined according to the target meta information set.

At block 206, the data and the corresponding blood relationship are stored into a data relationship database.

For example, the obtained information on the blood relationship corresponding to data 1 may be that data 1 is the data generated by performing the operation B in the application A, and its basic data path is Y, so that the data 1 and its corresponding blood relationship can be stored into the data relationship database.

It should be noted that the above examples are only exemplifications, and cannot be used as limitations on the data and the blood relationship corresponding thereto and the like in the embodiments of the present disclosure.

According to the embodiment of the present disclosure, data to be processed and initial meta information corresponding thereto will be acquired first, and afterwards in response to the initial meta information containing time information, the time information will be removed from the initial meta information, and the respective meta information sets in a meta information library, which are currently in a valid state, can be determined as the respective reference meta information sets. Afterwards in response to the initial meta information containing a distributed file identification and the respective reference meta information sets all corresponding to data warehouse tables, the distributed file identifications can be matched with identifications of distributed file systems in the respective reference meta information sets, and afterwards a target meta information set that matches the initial meta information can be determined, so that the blood relationship corresponding to the data can be determined according to the target meta information set, and the data and the blood relationship corresponding thereto can be stored into a data relationship database. Therefore, by removing the time information in advance, the influence caused by the time information when determining the blood relationship of the data can be reduced, so that each initial meta information can be fully matched, and the accuracy and comprehensiveness of the determination of the blood relationship of the data can be further improved.

In the above embodiment, by removing the time information in the initial meta information, the influence caused by the time information when determining the blood relationship of the data can be reduced, so that the accuracy of matching the initial meta information, and then according to the determined target meta information set that matches the initial meta information, the blood relationship corresponding to the data can be determined, and the data and the corresponding blood relationship can also be stored in the data relationship database. In a possible implementation, there may be a case where the initial meta information is matched with the respective reference meta information sets, but none is successfully matched. At this time, the initial meta information can be matched with a newly added reference meta information set, so as to determine the blood relationship corresponding to the data as much as possible, and the above process will be described with reference to FIG. 3 in detail below.

FIG. 3 is a schematic flowchart of a method for determining blood relationship of data provided by an embodiment of the present disclosure.

As shown in FIG. 3, the method for determining the blood relationship of the data may include the following steps.

At block 301, data to be processed and initial meta information corresponding thereto are acquired.

At block 302, the initial meta information is matched with respective reference meta information sets, respectively, to determine a target meta information set that matches the initial meta information.

At block 303, the data to be processed is marked as a blood relationship matching failure state in the case where the initial meta information matches none of the respective reference meta information sets.

When the initial meta information is matched with the respective reference meta information sets, if the meta information set related to the initial meta information has not been stored, there may be no reference meta information set that matches the initial meta information, so that the data to be processed corresponding to the initial meta information can be marked as a blood relationship matching failure state.

At block 304, a newly added reference meta information set is acquired.

Optionally, when acquiring the newly added reference meta information set, a registration request may be acquired first, and afterwards a connection request may be sent to a data server corresponding to a data source identification.

The registration request may include information such as the data source identification and a first secret key, which will not be limited by the present disclosure.

In addition, the data server may be a data warehouse table server or a distributed file system server, which will not be limited by the present disclosure.

Afterwards, in response to obtaining a connection response returned by the data server, a newly added meta information set and a second secret key corresponding to the data server may be determined.

The connection response returned by the data server may contain information such as the newly added meta information set, the second secret key corresponding to the data server and the like, which will not be limited by the present disclosure.

It is understandable that the connection response returned by the data server may contain one newly added meta information set, or may also contain multiple newly-added meta information sets, which will not be limited by the present disclosure.

Therefore, in the case where the first secret key matches the second secret key, the newly added meta information set can be determined as the newly added reference meta information set

For example, the information contained in the registration request may be data warehouse table A, first secret key XX, and afterwards a connection request can be sent to the data server corresponding to the data warehouse table A, and the obtained connection response returned by the data server may contain a newly added meta-information set B, a second secret key XX corresponding to the data server. The first secret key and the second secret key are the same, and it can be determined that the newly added meta-information set B is the newly-added reference meta-information set.

It should be noted that the above examples are only exemplifications, and cannot be used as limitation on the determination of the newly added reference meta-information set and the like in the embodiments of the present disclosure.

At block 305, the initial meta information is matched with the newly added reference meta information set, and determining, in the case where the newly added reference meta information set contains a meta information set that matches the initial meta information, the blood relationship corresponding to the data according to the meta information set that matches the initial meta information.

For example, the information contained in the initial meta-information 1 is: distributed file A, basic data path M, and secret key X, and the newly added reference meta-information set contains two meta-information sets of a meta-information set 1 and a meta information set 2. The information contained in the meta information set 1 is: distributed file A, basic data path M, basic data path N, secret key X, data ready identifier Z, etc., and the information contained in the meta information set 2 is: distributed file B, secret key Y, data ready identifier W. The meta-information set 1 contains all the information in the initial meta-information 1, so that it can be determined that the meta-information set 1 matches the initial meta-information 1. Afterwards, according to the meta-information set 1, the blood relationship corresponding to the data can be determined.

It should be noted that the above examples are only exemplifications, and cannot be used as limitation on the newly added reference meta-information set, the meta-information set matching the initial meta-information and the like in the embodiments of the present disclosure.

According to the embodiment of the present disclosure, data to be processed and initial meta information corresponding thereto will be acquired first, and afterwards the initial meta information will be matched with respective reference meta information sets, respectively, to determine a target meta information set that matches the initial meta information, and the data to be processed will be marked as a blood relationship matching failure state in the case where the initial meta information matches none of the respective reference meta information sets. Afterwards, a newly added reference meta information set can be acquired, and then the initial meta information will be matched with the newly added reference meta information set, and in the case where the newly added reference meta information set contains a meta information set that matches the initial meta information, the blood relationship corresponding to the data will be determined according to the meta information set that matches the initial meta information. Therefore, for the data, the matching of the blood relationship of which fails, it can continue to be matched with the newly added reference meta-information set, so that it can be ensured as much as possible that the objects, with which the data is matched, are more comprehensive and complete, so that the accuracy and reliability of the determined blood relationship of the data can be improved.

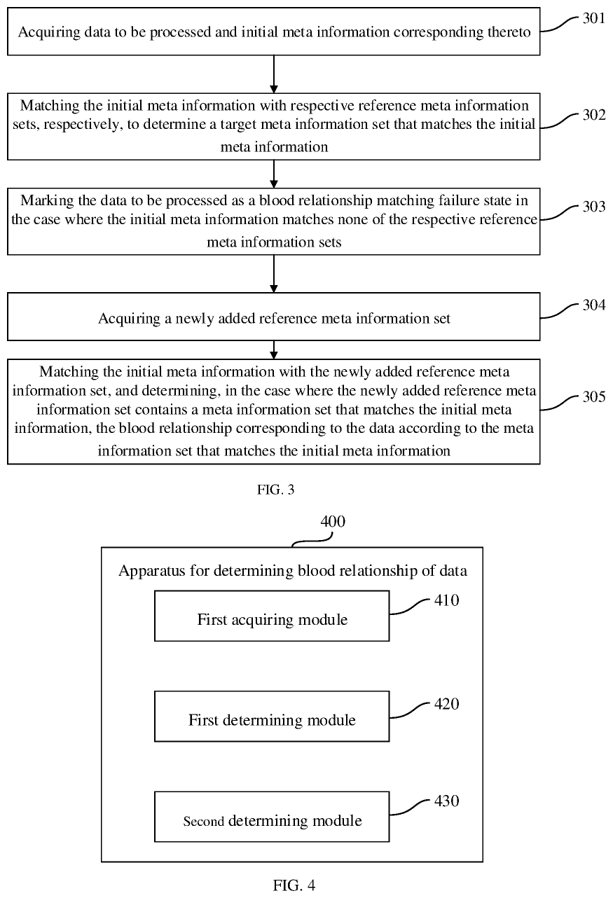

In order to implement the above embodiments, the present disclosure also proposes an apparatus for determining blood relationship of data. FIG. 4 is a schematic structural diagram of an apparatus for determining blood relationship of data provided by an embodiment of the present disclosure.

As shown in FIG. 4, the apparatus 400 for determining blood relationship of data includes: a first acquiring module 410, a first determining module 420, and a second determining module 430.

The first acquiring module 410 is configured for acquiring data to be processed and initial meta information corresponding thereto.

The first determining module 420 is configured for matching the initial meta information with respective reference meta information sets, respectively, to determine a target meta information set that matches the initial meta information;

The second determining module 430 is configured for determining the blood relationship corresponding to the data according to the target meta information set.

For the functions and specific implementation principles of the above-mentioned respective modules in the embodiment of the present disclosure, please refer to the above-described respective method embodiments, which will not be repeated here.

In the apparatus for determining blood relationship of data according to the embodiment of the present disclosure, data to be processed and initial meta information corresponding thereto will be acquired first, and afterwards the initial meta information can be matched with the respective reference meta information sets, respectively, to determine a target meta information set that matches the initial meta information, so that the blood relationship corresponding to the data can be determined according to the target meta information set. Therefore, the blood relationship corresponding to the data will be determined according to the matching result of the initial meta information corresponding to the data and the respective reference meta information sets, and because each reference meta information set can uniquely characterize the blood relationship of one piece of data, the risk of misjudgment of blood relationship of the data can be effectively reduced, and the accuracy and reliability of the determination of the blood relationship of the data can be improved.

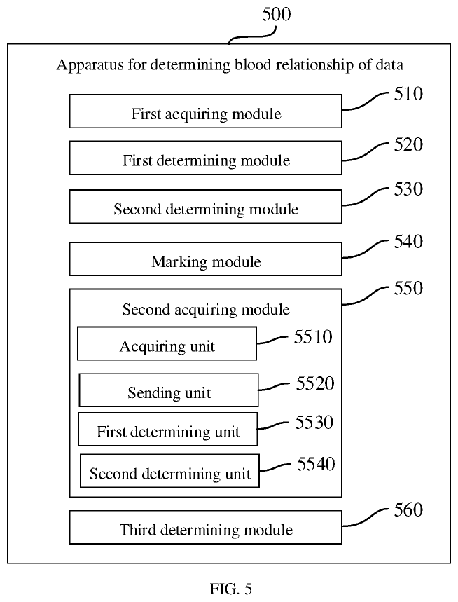

FIG. 5 is a schematic structural diagram of an apparatus for determining blood relationship of data provided by an embodiment of the present disclosure.

As shown in FIG. 5, the apparatus 500 for determining blood relationship of data includes: a first acquiring module 510, a first determining module 520, and a second determining module 530, a marking module 540, a second acquiring module 550 and a third determining module 560.

The first acquiring module 510 is configured for acquiring data to be processed and initial meta information corresponding thereto.

The first determining module 520 is configured for matching the initial meta information with respective reference meta information sets, respectively, to determine a target meta information set that matches the initial meta information;

The second determining module 530 is configured for determining the blood relationship corresponding to the data according to the target meta information set.

In a possible implementation, the first determining module 520 is further configured for determining respective meta information sets in a meta information library, which are currently in a valid state, as the respective reference meta information sets.

In a possible implementation, the first determining module 520 is further configured for removing, in response to the initial meta information containing time information, the time information from the initial meta information.

In a possible implementation, the first determining module 520 is specifically configured for matching, in response to the initial meta information containing a distributed file identification and the respective reference meta information sets all corresponding to a data warehouse table, the distributed file identification with identifications of distributed file systems in the respective reference meta information sets.

In a possible implementation, the first determining module 520 is further configured for storing the data and the blood relationship corresponding thereto into a blood relationship database.

In a possible implementation, the above apparatus 500 may further include:

the marking module 540, which is configured for marking the data to be processed as a blood relationship matching failure state in the case where the initial meta information matches none of the respective reference meta information sets.

In a possible implementation, the above apparatus 500 may further include:

the second acquiring module 550, which is configured for acquiring a newly added reference meta information set;

the third determining module 560, which is configured for matching the initial meta information with the newly added reference meta information set, and determining, in the case where the newly added reference meta information set contains a meta information set that matches the initial meta information, the blood relationship corresponding to the data according to the meta information set that matches the initial meta information.

In a possible implementation, the second acquiring module 550 includes:

an acquiring unit 5510, which is configured for acquiring a registration request, in which the registration request includes a data source identification and a first secret key;

a sending unit 5520, which is configured for sending a connection request to a data server corresponding to the data source identification;

a first determining unit 5530, which is configured for determining, in response to obtaining a connection response returned by the data server, a newly added meta information set and a second secret key corresponding to the data server;

a second determining unit 5540, which is configured for determining, in the case where the first secret key matches the second secret key, the newly added meta information set as the newly added reference meta information set.

It is understandable that the first acquiring module 510, the first determining module 520, and the second determining module 530 in the embodiment of the present disclosure may have the same structures and functions as the first acquiring module 410, the first determining module 420 and the second determining module 430 in the above embodiment, respectively.

For the functions and specific implementation principles of the above-mentioned respective modules in the embodiment of the present disclosure, please refer to the above-described respective method embodiments, which will not be repeated here.

In the apparatus for determining blood relationship of data according to the embodiment of the present disclosure, data to be processed and initial meta information corresponding thereto will be acquired first, and afterwards in response to the initial meta information containing time information, the time information will be removed from the initial meta information, and the respective meta information sets in a meta information library, which are currently in a valid state, can be determined as the respective reference meta information sets. Afterwards according to the determined target meta information set that matches the initial meta information, the blood relationship corresponding to the data can be determined and the data and the corresponding blood relationship will be stored into a data relationship database. The data to be processed may also be marked as a blood relationship matching failure state in the case where the initial meta information matches none of the respective reference meta information sets. Afterwards, a newly added reference meta information set can be acquired, and then the initial meta information will be matched with the newly added reference meta information set, and in the case where the newly added reference meta information set contains a meta information set that matches the initial meta information, the blood relationship corresponding to the data will be determined according to the meta information set that matches the initial meta information. Therefore, by removing the time information in advance, the influence caused by the time information when determining the blood relationship of the data can be reduced, and for the data, the matching of the blood relationship of which fails, it can continue to be matched with the newly added reference meta-information set, so that it can be ensured as much as possible that the objects, with which the data is matched, are more comprehensive and complete, so that the accuracy, comprehensiveness and reliability of the determined blood relationship of the data can be improved.

According to embodiments of the present disclosure, the present disclosure also provides an electronic device, a readable storage medium, and a computer program product.

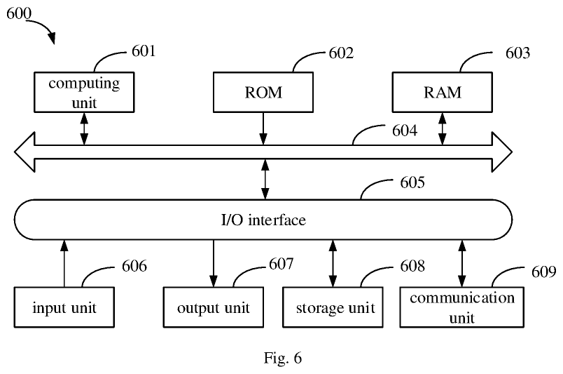

FIG. 6 shows a schematic block diagram of an example electronic device 600 that can be used to implement embodiments of the present disclosure. An electronic device is intended to represent various forms of digital computers, such as a laptop computer, a desktop computer, a workstation, a personal digital assistant, a server, a blade server, a mainframe computer and other suitable computers. An electronic device can also represent various forms of mobile apparatuses, such as personal digital processing, cellular phone, smart phone, a wearable device and other similar computing apparatuses. The components shown herein, their connections and relationships and their functions are merely examples, and are not intended to limit the implementation of the present disclosure described and/or required herein.

As shown in FIG. 6, the device 600 includes a computing unit 601, which can perform various suitable actions and processing according to a computer program stored in a read-only memory (ROM) 602 or a computer program loaded from a storage unit 608 to a random access memory (RAM) 603. In the RAM 603, various programs and data required for operations of the device 600 may also be stored. The computing unit 601, the ROM 602 and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, etc.; an output unit 607, such as various types of displays, speakers, etc.; and the storage unit 608, such as a disk, an optical disc, etc.; and a communication unit 609, such as a network card, a modem, a wireless communication transceiver, etc. The communication unit 609 allows the device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units that run machine learning model algorithms, a digital signal processing (DSP), and any suitable processor, controller, microcontroller, etc. The computing unit 601 executes the various methods and processes described above, such as the method for determining the blood relationship of the data. For example, in some embodiments, the method for determining the blood relationship of the data may be implemented as a computer software program, which is tangibly contained in a machine-readable medium, such as the storage unit 608. In some embodiments, part or all of the computer program may be loaded and/or installed onto the device 600 via the ROM 602 and/or the communication unit 609. When the computer program is loaded into the RAM 603 and executed by the computing unit 601, one or more steps of the method for determining the blood relationship of the data described above can be executed. Alternatively, in other embodiments, the computing unit 601 may be configured to perform the method for determining the blood relationship of the data in any other suitable manner (for example, by means of firmware).

The above various embodiments of the systems and technologies described herein can be implemented in a digital electronic circuit system, an integrated circuit system, a field programmable gate array (FPGA), an application specific integrated circuit (ASIC), an application-specific standard product (ASSP), a system of a system on chip (SOC), a load programmable logic device (CPLD), a computer hardware, firmware, software, and/or a combination thereof. These various embodiments may include: being implemented in one or more computer programs, which may be executed and/or interpreted on a programmable system including at least one programmable processor, the programmable processor may be a dedicated or general-purpose programmable processor that can receive data and instructions from a storage system, at least one input device and at least one output device, and transmit data and instructions to the storage system, the at least one input device and the at least one output device.

The program codes used to implement the method of the present disclosure can be written in any combination of one or more programming languages. These program codes can be provided to a processor or controller of a general-purpose computer, a special-purpose computer or other programmable data processing devices, so that when the program codes are executed by the processor or controller, the functions/operations specified in the flowcharts and/or block diagrams are implemented. The program codes can be executed entirely on a machine, partly executed on a machine, partly executed on a machine and partly executed on a remote machine as an independent software package, or entirely executed on a remote machine or a server.

In the context of the present disclosure, a machine-readable medium may be a tangible medium, which may contain or store a program for use by an instruction execution system, an apparatus or a device or for use in combination with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared or semiconductor system, an apparatus or a device or any suitable combination of the foregoing. More specific examples of the machine-readable storage medium may include electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combination of the foregoing.

In order to provide interaction with a user, the systems and technologies described here can be implemented on a computer, which has: a display apparatus for displaying information to the user (for example, a CRT (cathode ray tube) or LCD (liquid crystal display) monitor); and a keyboard and pointing apparatus (for example, a mouse or a trackball), through which the user can provide input to the computer. Other types of apparatuses can also be used to provide interaction with the user; for example, the feedback provided to the user can be any form of sensory feedback (for example, visual feedback, auditory feedback or tactile feedback); and input from the user can be received in any form (including acoustic input, voice input or tactile input).

The systems and technologies described here can be implemented in a computing system that includes back-end components (for example, as a data server), or a computing system that includes middleware components (for example, an application server), or a computing system that includes front-end components (for example, a user computer with a graphical user interface or a web browser, through which the user can interact with the embodiments of the systems and technologies described herein), or a computing system that includes any combination of such background components, middleware Components or front-end components. The components of the system can be connected to each other through any form or medium of digital data communication (for example, a communication network). Examples of the communication network include: a local area network (LAN), a wide area network (WAN), the Internet, and a blockchain network.

The computer system may include a client and a server. The client and the server are generally far away from each other and usually interact through a communication network. The relationship between the client and the server will be generated by a computer program that runs on a corresponding computer and has a client-server relationship with each other. The server may be a cloud server, also known as a cloud computing server or a cloud host, which is a host product in a cloud computing service system to solve the defect of the existed shortcomings of difficult management and weak business scalability in the traditional physical host and VPS service (“Virtual Private Server”, or “VPS” for short). The server may also be a server of a distributed system, or a server combined with a blockchain.

In the technical solution of the present disclosure, data to be processed and initial meta information corresponding thereto will be acquired first, and afterwards the initial meta information can be matched with the respective reference meta information sets, respectively, to determine a target meta information set that matches the initial meta information, so that the blood relationship corresponding to the data can be determined according to the target meta information set. Therefore, the blood relationship corresponding to the data will be determined according to the matching result of the initial meta information corresponding to the data and the respective reference meta information sets, and because each reference meta information set can uniquely characterize the blood relationship of one piece of data, the risk of misjudgment of blood relationship of the data can be effectively reduced, and the accuracy and reliability of the determination of the blood relationship of the data can be improved.

It should be understood that the various forms of flows shown above can be used to reorder, add or delete steps. For example, the respective steps described in the present disclosure may be executed in parallel, or also may be executed sequentially, or also may be executed in a different order, as long as the desired result of the technical solution disclosed in the present disclosure can be achieved, and will be not limited herein.

The foregoing specific embodiments do not constitute limitation on the protection scope of the present disclosure. Those skilled in the art should understand that various modifications, combinations, sub-combinations and substitutions can be made according to design requirements and other factors. Any modification, equivalent replacement and improvement and the like made within the spirit and principle of the present disclosure shall be included in the protection scope of the present disclosure.

What is claimed is:

1. A method for determining blood relationship of data, comprising:
acquiring data to be processed and initial meta information corresponding the data;
matching the initial meta information with respective reference meta information sets, respectively, to determine a target meta information set that matches the initial meta information; and
determining the blood relationship corresponding to the data based on the target meta information set.

2. The method according to claim 1, further comprising:
determining meta information sets currently in a valid state in a meta information library as the respective reference meta information sets.

3. The method according to claim 1, further comprising:
removing, in response to the initial meta information containing time information, the time information from the initial meta information.

4. The method according to claim 1, wherein matching the initial meta information with the respective reference meta information sets, respectively, comprises:
matching, in response to the initial meta information containing a distributed file identification and the respective reference meta information sets all corresponding to a data warehouse table, the distributed file identification with identifications of distributed file systems in the respective reference meta information sets.

5. The method according to claim 1, further comprising:
storing the data and the blood relationship into a blood relationship database.

6. The method according to claim 1, further comprising:
marking the data as a blood relationship matching failure state in case where the initial meta information matches none of the respective reference meta information sets.

7. The method according to claim 6, further comprising:
acquiring a newly added reference meta information set;
matching the initial meta information with the newly added reference meta information set, and determining, in case where the newly added reference meta information set contains a meta information set that matches the initial meta information, the blood relationship corresponding to the data based on the meta information set that matches the initial meta information.

8. The method according to claim 7, wherein acquiring the newly added reference meta information set comprises:
acquiring a registration request, wherein the registration request comprises a data source identification and a first secret key;
sending a connection request to a data server corresponding to the data source identification;
determining, in response to obtaining a connection response returned by the data server, a newly added meta information set and a second secret key corresponding to the data server;
determining, in case where the first secret key matches the second secret key, the newly added meta information set as the newly added reference meta information set.

9. An electronic device, comprising:
at least one processor; and
a memory communicatively connected with the at least one processor; wherein,
instructions executable by the at least one processor are stored in the memory, and the instructions are executed by the at least one processor, so that the at least one processor can execute the method for determining blood relationship of data, comprising:
acquiring data to be processed and initial meta information corresponding the data;
matching the initial meta information with respective reference meta information sets, respectively, to determine a target meta information set that matches the initial meta information; and
determining the blood relationship corresponding to the data based on the target meta information set.

10. The device according to claim 9, wherein the method further comprises:
determining meta information sets currently in a valid state in a meta information library as the respective reference meta information sets.

11. The device according to claim 9, wherein the method further comprises:
removing, in response to the initial meta information containing time information, the time information from the initial meta information.

12. The device according to claim 9, wherein matching the initial meta information with the respective reference meta information sets, respectively, comprises:
matching, in response to the initial meta information containing a distributed file identification and the respective reference meta information sets all corresponding to a data warehouse table, the distributed file identification with identifications of distributed file systems in the respective reference meta information sets.

13. The device according to claim 9, wherein the method further comprises:
storing the data and the blood relationship into a blood relationship database.

14. The device according to claim 9, wherein the method further comprises:
marking the data as a blood relationship matching failure state in case where the initial meta information matches none of the respective reference meta information sets.

15. The device according to claim 14, wherein the method further comprises:
acquiring a newly added reference meta information set;
matching the initial meta information with the newly added reference meta information set, and determining, in case where the newly added reference meta information set contains a meta information set that matches the initial meta information, the blood relationship corresponding to the data based on the meta information set that matches the initial meta information.

16. The device according to claim 15, wherein acquiring the newly added reference meta information set comprises:
acquiring a registration request, wherein the registration request comprises a data source identification and a first secret key;
sending a connection request to a data server corresponding to the data source identification;
determining, in response to obtaining a connection response returned by the data server, a newly added meta information set and a second secret key corresponding to the data server;
determining, in case where the first secret key matches the second secret key, the newly added meta information set as the newly added reference meta information set.

17. A non-transitory computer-readable storage medium, having computer instructions stored therein, wherein the computer instructions are configured to cause a computer to execute the method for determining blood relationship of data, comprising:
acquiring data to be processed and initial meta information corresponding the data;
matching the initial meta information with respective reference meta information sets, respectively, to determine a target meta information set that matches the initial meta information; and
determining the blood relationship corresponding to the data based on the target meta information set.

18. The storage medium according to claim 17, wherein the method further comprises:
determining meta information sets currently in a valid state in a meta information library as the respective reference meta information sets.

19. The storage medium according to claim 17, wherein the method further comprises:
removing, in response to the initial meta information containing time information, the time information from the initial meta information.

20. The storage medium according to claim 17, wherein matching the initial meta information with the respective reference meta information sets, respectively, comprises:
matching, in response to the initial meta information containing a distributed file identification and the respective reference meta information sets all corresponding to a data warehouse table, the distributed file identification with identifications of distributed file systems in the respective reference meta information sets.
